(19) United States
(12) Patent Application Publication
(10) Pub. No.: US 2026/0328966 A1
(43) Pub. Date: Oct. 22, 2026

(54) SHORT-TERM PREDICTION METHOD, SYSTEM, AND DEVICE FOR URBAN LOW-ALTITUDE WIND FIELDS

(71) Applicant: NingboTech University, Ningbo (CN)

(72) Inventors: Qiang Li, Ningbo (CN); Liangbo Sun, Ningbo (CN); Ping Wu, Ningbo (CN); Yidong Xu, Ningbo (CN); Jun Zhang, Ningbo (CN); Maomao Yang, Ningbo (CN)

(21) Appl. No.: 19/686,844

(22) Filed: May 25, 2026

(30) Foreign Application Priority Data
Mar. 3, 2026 (CN) 202610251734.X

(51) Int. Cl. G01W 1/10

(52) U.S. Cl. CPC G01W 1/10

(57) ABSTRACT

The present invention discloses short-term prediction method, system, and device for urban low-altitude wind fields, relating to the field of urban wind field prediction. The scheme includes obtaining historical wind speed component data, combining a wind direction inference module to obtain a target incoming wind direction accordingly, and combining a time series prediction module to obtain predicted wind speed component data of A meteorological stations in a future time period; Selecting a target physical-informed spatial mapping module corresponding to the target incoming wind direction, and obtaining the predicted wind speed component data and the predicted pressure data corresponding to each grid node under the preset pedestrian-level structured grid according to the predicted wind speed component data, the preset pedestrian-level structured grid, the binary mask vector for buildings in the target city, and the target physical-informed spatial mapping module.

### TECHNICAL FIELD

The present invention relates to the technical field of urban wind field prediction, and more particularly, to short-term prediction method, system, and device for urban low-altitude wind fields.

### BACKGROUND ART

In cities, low-altitude wind fields corresponding to pedestrian heights are crucial for wind disaster early warning, outdoor comfort evaluation, and low-altitude operation safety. Therefore, it is necessary to accurately predict urban low-altitude wind fields; Specifically, current analysis schemes for urban low-altitude wind fields mainly focus on flow field reconstruction, that is, using sparse observation data at a certain moment to infer the overall flow field distribution at the same moment. However, this flow field reconstruction focuses on filling the information gap in unobserved spaces and cannot directly support the prediction needs for future wind fields; Other methods, such as field measurements, wind tunnel tests, large eddy simulations, and computational fluid dynamics, which determine urban low-altitude wind fields with high fidelity, are time-consuming and costly, making it difficult to meet the rapid prediction needs of urban low-altitude wind fields. Therefore, there is a need for a technical scheme capable of achieving rapid and accurate prediction of urban low-altitude wind fields.

### SUMMARY OF THE INVENTION

The problem to be solved by the present invention is: To provide short-term prediction method, system, and device for urban low-altitude wind fields, and present a data-physics integrated prediction scheme for urban near-surface wind fields based on sparse multi-station historical time series data, realizing future global wind field prediction with higher prediction accuracy and efficiency.

In order to solve the above technical problem, the present application provides short-term prediction method for urban low-altitude wind fields, comprising:
Obtain the historical wind speed component data of A meteorological stations in a target city within a preset historical time period, where A is an integer greater than 1;
Input the historical wind speed component data as an input item into a wind direction inference module to obtain the target incoming wind direction corresponding to the target city;
Input the historical wind speed component data as an input item into a time series prediction module to obtain predicted wind speed component data of A meteorological stations in a future time period;
Select a target physical-informed spatial mapping module corresponding to the target incoming wind direction from pre-trained physical-informed spatial mapping modules;
Input the predicted wind speed component data, a preset pedestrian-level structured grid corresponding to the target city, and a binary mask vector for buildings in the target city as input items into the pre-trained target physical-informed spatial mapping module, to obtain the predicted wind speed component data and the predicted pressure data corresponding to each grid node under the preset pedestrian-level structured grid.

The beneficial effects of the present invention are:

This scheme can utilize the historical wind speed component data of sparse multi-meteorological stations under a preset historical time period, accurately determine the target incoming wind direction relying on a wind speed inference module, and determine a target physical-informed spatial mapping module based on the target incoming wind direction, so as to ensure the accuracy when subsequently mapping the predicted wind speed component results to the global low-altitude wind field; Accurately determine the predicted wind speed component data of A meteorological stations in a future time period relying on a time series prediction module, and then combine the target physical-informed spatial mapping module under a preset pedestrian-level structured grid to predict the low-altitude, near-surface wind field of the target city in the future time period, realizing future global wind field prediction with higher prediction accuracy and efficiency, which is conducive to practical application.

Further, inputting the historical wind speed component data as an input item into a wind direction inference module to obtain the target incoming wind direction corresponding to the target city comprises:
Perform feature extraction on the historical wind speed component data to obtain a feature vector;
Use a first linear layer to perform linear transformation processing on the feature vector to obtain a first linear output vector, and use a first activation function to activate the first linear output vector to obtain a first activation vector;
Use a second linear layer to perform linear transformation processing on the first activation vector to obtain a second linear output vector, and use the first activation function to activate the second linear output vector to obtain a second activation vector; Wherein, the dimension of the first linear output vector is higher than the dimension of the second linear output vector;
Use a third linear layer to perform linear transformation processing on the second activation vector to obtain a third linear output vector; Wherein, the dimension of the second linear output vector is higher than the dimension of the third linear output vector;
Determine the target incoming wind direction corresponding to the target city based on the third linear output vector and a preset direction category determination strategy.

Further, determining the target incoming wind direction corresponding to the target city based on the third linear output vector and a preset direction category determination strategy comprises:
Use a Softmax function to normalize the third linear output vector to obtain probability values corresponding to X incoming wind directions, where X is equal to the dimension of the third linear output vector;
Select the maximum value among the probability values to determine the incoming wind direction corresponding to the maximum value as the target incoming wind direction corresponding to the target city.

Further, inputting the historical wind speed component data as an input item into a time series prediction module to obtain predicted wind speed component data of A meteorological stations in a future time period comprises:
Merge the historical wind speed component data corresponding to each historical time step within the preset historical time period into historical wind speed data;

For the historical wind speed data under each historical time step, execute the following steps:
Based on a forward LSTM layer, start from the historical wind speed data under the first historical time step and sequentially process to the historical wind speed data under the last historical time step, to correspondingly obtain a forward hidden state representation under each historical time step;
Based on a backward LSTM layer, start from the historical wind speed data under the last historical time step and reversely process to the historical wind speed data under the first historical time step, to correspondingly obtain a backward hidden state representation under each historical time step;
For each historical time step, concatenate the forward hidden state representation and the backward hidden state representation under the historical time step to obtain a bidirectional hidden state representation under the historical time step;
Determine the predicted wind speed component data of the A meteorological stations in the future time period according to the bidirectional hidden state representation under each historical time step.

Further, determining the predicted wind speed component data of the A meteorological stations in the future time period according to the bidirectional hidden state representation under each historical time step comprises:
Use a dropout layer to perform a random dropout operation on the bidirectional hidden state under each historical time step to obtain a regularized bidirectional hidden state representation under each historical time step, and input it as an input item to a fully connected layer for mapping processing, to obtain the predicted wind speed data of the A meteorological stations in the future time period;
Decompose the predicted wind speed data in the x direction and the y direction, respectively, to correspondingly obtain the predicted wind speed component data in the x direction and the predicted wind speed component data in the y direction.

Further, the physical-informed spatial mapping module is a graph neural network, and the graph neural network is pre-trained based on a training dataset and a preset loss function;

The preset loss function is:

LOSS=αLOSS_{data}+βLOSS_{physics}

Wherein, Loss represents training error, Loss_{data} represents data loss and Loss_{data} is determined based on a preset data loss calibration strategy, α is a first weight corresponding to Loss_{data}, Loss_{physics} represents physical residual loss and Loss_{physics} is determined based on the incompressible Navier-Stokes equations, and β is a second weight corresponding to Loss_{physics}.

Further, determining Loss_{data} based on a preset data loss calibration strategy comprises:

Determining Loss_{data} based on a first preset relational expression, and the first preset relational expression is:

LOSS_{data}=|u−ū|²+|v−v̅|²+|p−p̅|²

Wherein, u represents the predicted wind speed component data in the x direction corresponding to the grid node under the preset pedestrian-level structured grid obtained when predicting using the graph neural network to be trained, ū represents the true wind speed component data in the x direction corresponding to the grid node, v represents the predicted wind speed component data in the y direction corresponding to the grid node, v represents the true wind speed component data in the y direction corresponding to the grid node, p represents the predicted pressure data corresponding to the grid node, and p̅ represents the true pressure data corresponding to the grid node.

Further, determining Loss_{physics} based on the incompressible Navier-Stokes equations comprises:

Determine Loss_{physics} based on a second preset relational expression, the second preset relational expression is:

Loss_{physics}=MSE_{f}_{₁}+MSE_{f}_{₂}+MSE_{f}_{₃}

MSE_{f}_{₁} represents the mean square error corresponding to the continuity equation f₁ in the incompressible Navier-Stokes equations, MSE_{f}_{₂} represents the mean square error corresponding to the x-direction momentum equation f₂ in the incompressible Navier-Stokes equations, and MSE_{f}_{₃} represents the mean square error corresponding to the y-direction momentum equation f₃ in the incompressible Navier-Stokes equations;

Wherein, the incompressible Navier-Stokes equations are:

$$\{ \begin{matrix}{f}_{1} = {u}_{x} + {u}_{y} \\ {f}_{2} = {uu}_{x} + {vu}_{y} + {p}_{x} - \frac{1}{{R}_{e}} ( {u}_{xx} + {u}_{yy} ) \\ {f}_{3} = {uv}_{x} + {vv}_{y} + {p}_{y} - \frac{1}{{R}_{e}} ( {v}_{xx} + {v}_{yy} )\end{matrix}$$

Wherein, uₓ represents the first-order partial derivative of u with respect to the x direction, u_{y} represents the first-order partial derivative of u with respect to the y direction, pₓ represents the first-order partial derivative of p with respect to the x direction, Rₑ represents the Reynolds number, uₓ represents the second-order partial derivative of u with respect to the x direction, u_{yy} represents the second-order partial derivative of u with respect to the y direction, vₓ represents the first-order partial derivative of v with respect to the x direction, v_{y} represents the first-order partial derivative of v with respect to the y direction, vₓₓ represents the second-order partial derivative of v with respect to the x direction, and v_{yy} represents the second-order partial derivative of v with respect to the y direction.

In order to solve the above technical problem, the present invention further provides short-term prediction system for urban low-altitude wind fields, comprising:
An acquisition module, configured for obtaining the historical wind speed component data of A meteorological stations in a target city within a preset historical time period, where A is an integer greater than 1;
A wind direction inference module, configured for obtaining the target incoming wind direction corresponding to the target city according to the historical wind speed component data;
A time series prediction module, configured for obtaining the predicted wind speed component data of the A meteorological stations in a future time period according to the historical wind speed component data;
A selection module, configured for selecting a target physical-informed spatial mapping module corresponding to the target incoming wind direction from pre-trained physical-informed spatial mapping modules;
The target physical-informed spatial mapping module, configured for obtaining the predicted wind speed component data and the predicted pressure data corresponding to each grid node under the preset pedestrian-level structured grid, according to the predicted wind speed component data, the preset pedestrian-level structured grid corresponding to the target city, and a binary mask vector for buildings in the target city.

In order to solve the above technical problem, the present invention further provides short-term prediction device for urban low-altitude wind fields, comprising:
A memory, configured for storing a computer program;
A processor, configured to, when executing the computer program, implement the steps of short-term prediction method for urban low-altitude wind fields as described above.

### BRIEF DESCRIPTION OF THE DRAWINGS

The drawings illustrated herein are used to provide a further understanding of the present application and constitute a part of the present application. The exemplary embodiments of the present application and the descriptions thereof are used to explain the present application and do not constitute an improper limitation of the present application. In the drawings:

FIG. 1 is a flowchart of short-term prediction method for urban low-altitude wind fields provided by the present invention;

FIG. 2 is a schematic diagram of a processing process of short-term prediction method for urban low-altitude wind fields provided by the present invention;

FIG. 3 is a schematic structural diagram of a wind direction inference module provided by the present invention;

FIG. 4 is a schematic structural diagram of a time series prediction module provided by the present invention;

FIG. 5 is a schematic diagram comparing prediction results with validation benchmarks provided by the present invention;

FIG. 6 is another schematic diagram comparing prediction results with validation benchmarks provided by the present invention;

FIG. 7 is a schematic diagram of the statistical distribution of the predicted wind speed component data in the x direction and the predicted wind speed component data in the y direction under a 225° target incoming wind direction provided by the present invention;

FIG. 8 is a schematic diagram of the statistical distribution of the predicted wind speed component data in the x direction and the predicted wind speed component data in the y direction under a 315° target incoming wind direction provided by the present invention;

FIG. 9 is a schematic diagram comparing prediction results with validation benchmarks under a 45° target incoming wind direction provided by the present invention;

FIG. 10 is another schematic diagram comparing prediction results with validation benchmarks under a 45° target incoming wind direction provided by the present invention;

FIG. 11 is a schematic structural diagram of short-term prediction system for urban low-altitude wind fields provided by the present invention;

FIG. 12 is a schematic structural diagram of short-term prediction device for urban low-altitude wind fields provided by the present invention.

### DETAILED DESCRIPTION OF THE EMBODIMENTS

The core of the present invention is to provide short-term prediction method, system, and device for urban low-altitude wind fields, presenting a data-physics integrated prediction scheme for urban near-surface wind fields based on sparse multi-station historical time series data, realizing future global wind field prediction with higher prediction accuracy and efficiency.

To make the above objects, features, and advantages of the present invention more apparent and understandable, specific embodiments of the present invention will be described in detail below with reference to the accompanying drawings.

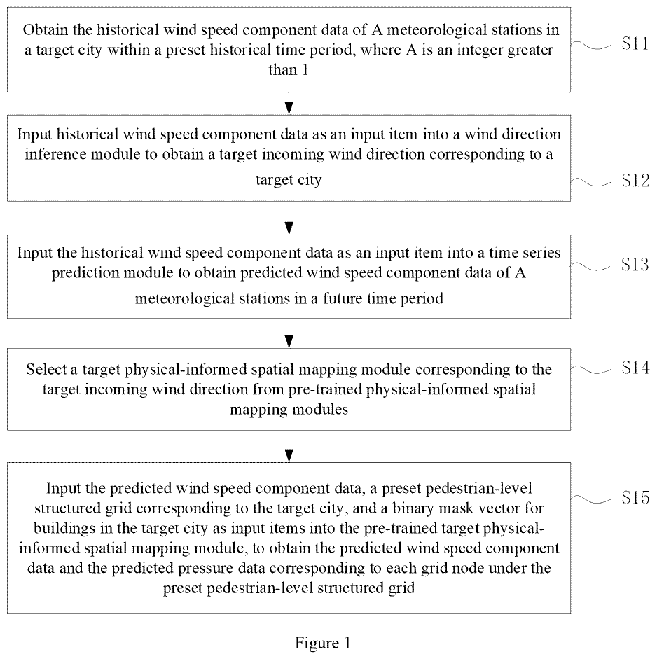

Please refer to FIG. 1, which is a flowchart of short-term prediction method for urban low-altitude wind fields provided by the present invention.

The short-term prediction method for urban low-altitude wind fields comprises:
S11: Obtain the historical wind speed component data of A meteorological stations in a target city within a preset historical time period, where A is an integer greater than 1;
S12: Input historical wind speed component data as an input item into a wind direction inference module to obtain a target incoming wind direction corresponding to a target city;
S13: Input the historical wind speed component data as an input item into a time series prediction module to obtain predicted wind speed component data of A meteorological stations in a future time period;
S14: Select a target physical-informed spatial mapping module corresponding to the target incoming wind direction from pre-trained physical-informed spatial mapping modules;
S15: Input the predicted wind speed component data, a preset pedestrian-level structured grid corresponding to the target city, and a binary mask vector for buildings in the target city as input items into the pre-trained target physical-informed spatial mapping module, to obtain the predicted wind speed component data and the predicted pressure data corresponding to each grid node under the preset pedestrian-level structured grid.

In this embodiment, this scheme focuses on future global wind field prediction for the target city, rather than instantaneous flow field reconstruction, and provides a data-physics integrated prediction scheme for urban near-surface wind fields based on sparse multi-station historical time series data. Here, the sparse multi-station historical time series data refers to historical wind speed component data of A meteorological stations within a preset time period, and data-physics integrated prediction refers to mapping the predicted wind speed component data of the A meteorological stations in a future time period to the physical space of the entire target city through the target physical-informed spatial mapping module.

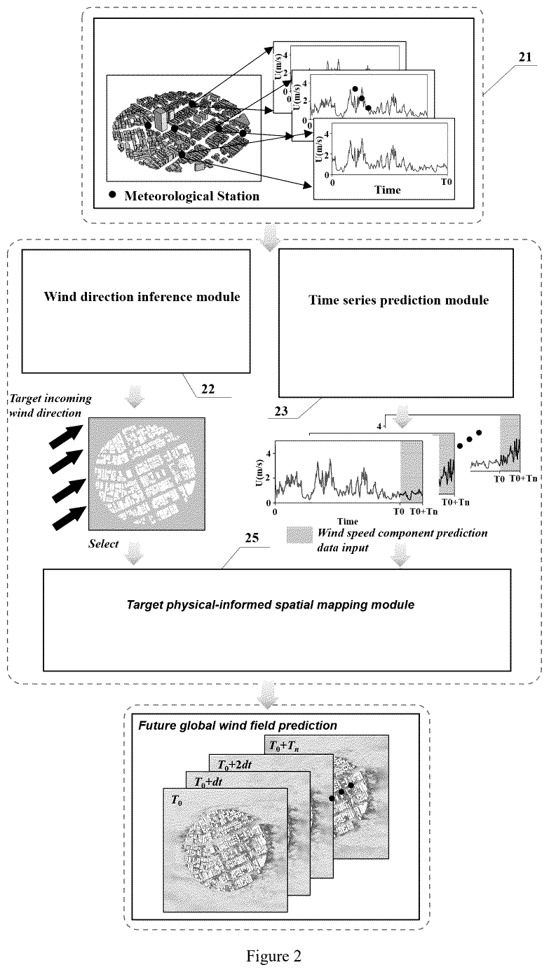

Specifically, the A meteorological stations are sparsely arranged in the target city. There is no particular limitation on their specific arrangement positions, nor is there any particular limitation on the total number of meteorological stations. For example, A=30; The preset historical time period may include B time steps, where B is an integer greater than 1, to obtain the historical wind speed component data of each meteorological station under the B time steps. Here, the historical wind speed component data specifically includes historical wind speed component data in the x direction and historical wind speed component data in the y direction, and the x direction and the y direction can be understood as the x direction and the y direction defined by a two-dimensional orthogonal coordinate system applied to the geographical space of the target city; It can be understood that the historical wind speed component data here is data corresponding to the low-altitude wind field (that is, the pedestrian-level wind field) of the target city. Please refer to FIG. 2, which is a schematic diagram of a processing process of short-term prediction method for urban low-altitude wind fields provided by the present invention, wherein an acquisition module 21 provides an extraction illustration of historical wind speed data for multiple meteorological stations in the target city within a preset historical time period. In the extraction results, the vertical coordinate U represents historical wind speed data, and this historical wind speed data is decomposed into the x direction and the y direction respectively to obtain the historical wind speed component data, while the vertical coordinate Time represents time. In addition, as a data preprocessing step, time series synchronization can also be performed on the historical wind speed component data of the A meteorological stations within the preset historical time period, which is not particularly limited herein.

According to step S12, the wind direction inference module 22 can realize perceptive decomposition of various incoming wind directions to determine the target incoming wind direction corresponding to the target city, which is also a key setting for the present application to achieve accurate wind field prediction; According to step S13, the time series prediction module 23 can determine predicted wind speed component data of the A meteorological stations in a future time period. Here, the future time period includes C time steps, where C is an integer greater than 1, and what the present application implements is short-term prediction, that is, C is less than a preset threshold. For example, C=3; Please refer to FIG. 2, the portion T0~T0+Tn for each meteorological station corresponds to the illustration of the future time period.

Physical-informed spatial mapping modules are trained in advance to correspond one-to-one with various incoming wind directions. For example, it can be targeted at 16 incoming wind directions, that is, selecting and setting incoming wind directions from 0° to 360° at angular intervals of 22.5°; Then relying on step S14, the target physical-informed spatial mapping module 25 corresponding to the current target incoming wind direction can be determined, and further based on step S15, future global wind field prediction is realized. As shown in FIG. 2, here T₀ represents the current time step, T₀+dt represents the next time step, and so on, T₀+Tₙ represents the last predictable time step.

More specifically, what is obtained in step S13 is the predicted wind speed component data of the A meteorological stations in the future time period, and it is necessary to realize global-range wind field prediction for the entire target city through step S15; It should be noted that the preset pedestrian-level structured grid here is a grid set in advance, corresponding to the low-altitude wind field of the target city, capable of simulating different locations within the global range of the target city in the form of grid nodes; The preset pedestrian-level structured grid may specifically include grid node coordinates and directed edge adjacency relationships of adjacent nodes, and this relationship may specifically be embodied by the Euclidean distance of adjacent edges. Thus, the preset pedestrian-level structured grid can be represented by Q=(V, E), where V represents a set of grid nodes, and E represents a set of directed edge adjacency relationships of adjacent nodes; In addition, a binary mask vector of buildings in the target city serves as a physical entity area identifier. Finally, based on step S15, the predicted wind speed component data and predicted pressure data corresponding to each grid point are determined, realizing global low-altitude wind field prediction.

In summary, the present application provides short-term prediction method for urban low-altitude wind fields. This scheme can utilize historical wind speed component data of sparse multi-meteorological stations under a preset historical time period, rely on a wind speed inference module to accurately determine a target incoming wind direction, and determine a target physical-informed spatial mapping module based on the target incoming wind direction, so as to ensure the accuracy when subsequently mapping predicted wind speed component results to the global low-altitude wind field; Relying on a time series prediction module to accurately determine predicted wind speed component data of A meteorological stations in a future time period, and then combining the target physical-informed spatial mapping module under a preset pedestrian-level structured grid, predicting the low-altitude, near-surface wind field of the target city in the future time period, realizing future global wind field prediction with higher prediction accuracy and efficiency, which is conducive to providing wind field prediction results for various urban scenarios including wind disaster early warning, pollutant dispersion analysis, and pedestrian comfort evaluation, and is beneficial to practical application.

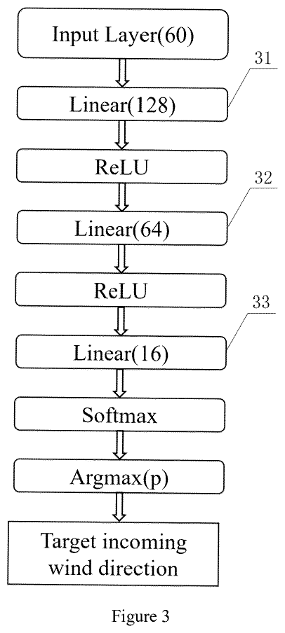

Please refer to FIG. 3, which is a schematic structural diagram of a wind direction inference module provided by the present invention.

In some embodiments, inputting historical wind speed component data as an input item into a wind direction inference module to obtain a target incoming wind direction corresponding to a target city comprises:
Perform feature extraction on the historical wind speed component data to obtain a feature vector;
Use a first linear layer 31 to perform linear transformation processing on the feature vector to obtain a first linear output vector, and use a first activation function to activate the first linear output vector to obtain a first activation vector;
Use a second linear layer 32 to perform linear transformation processing on the first activation vector to obtain a second linear output vector, and use the first activation function to activate the second linear output vector to obtain a second activation vector; Wherein, the dimension of the first linear output vector is higher than the dimension of the second linear output vector;
Use a third linear layer 33 to perform linear transformation processing on the second activation vector to obtain a third linear output vector; Wherein, the dimension of the second linear output vector is higher than the dimension of the third linear output vector;
Determine the target incoming wind direction corresponding to the target city based on the third linear output vector and a preset direction category determination strategy.

Specifically, Input Layer is used in FIG. 3 to indicate feature extraction to obtain a feature vector. Corresponding to the above example of A=30 for illustration, the feature vector here is 60-dimensional, concatenated from x-direction wind speed feature components and y-direction wind speed feature components of 30 meteorological stations; The first linear layer 31 may include 128 neurons, so as to correspondingly obtain a 128-dimensional first linear output vector. The first activation function here may be a RELU activation function as illustrated in FIG. 3; The second linear layer 32 may include 64 neurons, so as to correspondingly obtain a 64-dimensional second linear output vector; The third linear layer 33 may include 16 neurons, so as to correspondingly obtain a 16-dimensional third linear output vector. It can be understood that this 16-dimensional third linear output vector essentially corresponds to 16 possible incoming wind direction categories.

Further, in some embodiments, determining the target incoming wind direction corresponding to the target city based on the third linear output vector and a preset direction category determination strategy comprises:
Use a Softmax function to normalize the third linear output vector to obtain probability values corresponding to X incoming wind directions, where X is equal to the dimension of the third linear output vector;
Select the maximum value among the probability values to determine the incoming wind direction corresponding to the maximum value as the target incoming wind direction corresponding to the target city.

Specifically, corresponding to the above example, X=16; Then according to the above setting, the target incoming wind direction corresponding to the target city can be reliably determined. It should be noted that the step of selecting the maximum probability value is denoted by Argmax (p) in FIG. 3.

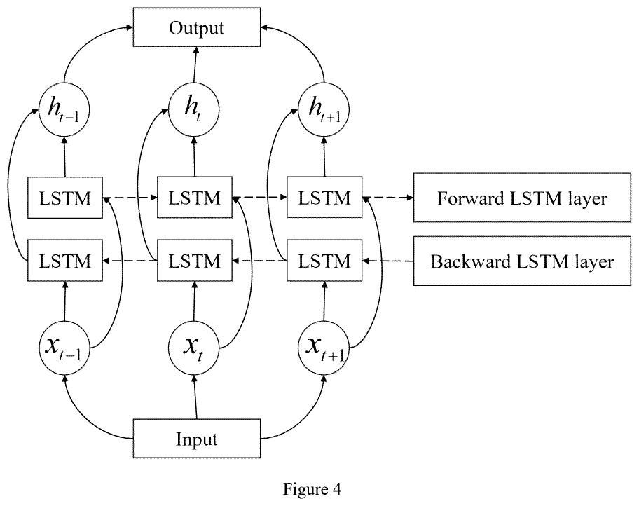

Please refer to FIG. 4, which is a schematic structural diagram of a time series prediction module provided by the present invention.

In some embodiments, inputting the historical wind speed component data as an input item into a time series prediction module to obtain predicted wind speed component data of A meteorological stations in a future time period comprises:
Merge the historical wind speed component data corresponding to each historical time step within the preset historical time period into historical wind speed data;

For the historical wind speed data under each historical time step, execute the following steps:
Based on a forward LSTM layer, start from the historical wind speed data under the first historical time step and sequentially process to the historical wind speed data under the last historical time step, to correspondingly obtain a forward hidden state representation under each historical time step;
Based on a backward LSTM layer, start from the historical wind speed data under the last historical time step and reversely process to the historical wind speed data under the first historical time step, to correspondingly obtain a backward hidden state representation under each historical time step;
For each historical time step, concatenate the forward hidden state representation and the backward hidden state representation under the historical time step to obtain a bidirectional hidden state representation under the historical time step;
Determine the predicted wind speed component data of the A meteorological stations in the future time period according to the bidirectional hidden state representation under each historical time step.

In some embodiments, determining the predicted wind speed component data of the A meteorological stations in the future time period according to the bidirectional hidden state representation under each historical time step comprises:
Use a dropout layer to perform a random dropout operation on the bidirectional hidden state under each historical time step to obtain a regularized bidirectional hidden state representation under each historical time step, and input it as an input item to a fully connected layer for mapping processing, to obtain the predicted wind speed data of the A meteorological stations in the future time period;
Decompose the predicted wind speed data in the x direction and the y direction, respectively, to correspondingly obtain the predicted wind speed component data in the x direction and the predicted wind speed component data in the y direction.

Specifically, the forward LSTM layer and the backward LSTM layer here can be essentially understood as a bidirectional LSTM, and both are set based on LSTM (Long Short-Term Memory). The bidirectional LSTM can extract rich time series representations from historical wind speed data under each historical time step, and is beneficial for alleviating the training instability problem commonly encountered by models when learning long-range dependencies; Then according to the above setting, predicted wind speed component data of the A meteorological stations in the future time period can be obtained. It should be noted that FIG. 4 takes 3 historical time steps, namely t−1, t, and t+1, as an example for illustration, wherein xₜ₋₁ represents historical wind speed data under the t−1 historical time step, xₜ represents historical wind speed data under the t historical time step, and xₜ₊₁ represents historical wind speed data under the t+1 historical time step; hₜ₋₁ represents a bidirectional hidden state representation under the t−1 historical time step, hₜ represents a bidirectional hidden state representation under the t historical time step, and hₜ₊₁ represents a bidirectional hidden state representation under the t+1 historical time step; In addition, limited by the display focus of the picture in FIG. 3, the setting illustration for the dropout layer and the fully connected layer is temporarily omitted.

It also needs to be noted that for an input sequence, that is, historical wind speed data under each historical time step, the forward LSTM layer processes the input sequence along the forward direction sequentially, and the backward LSTM layer processes the input sequence along the backward direction in reverse order. Each LSTM layer independently maintains its own input, output, and hidden states. By jointly utilizing information from both directions, the bidirectional LSTM can more effectively capture bidirectional dependencies in sequence data, demonstrating superior performance and considerable application potential. As for specific processing steps of LSTM, they have been detailed in the prior art, and will not be repeated here.

In some embodiments, the physical-informed spatial mapping module is a graph neural network, and the graph neural network is pre-trained based on a training dataset and a preset loss function;

The preset loss function is:

Loss=αLoss_{data}+βLoss_{physics}

Wherein, Loss represents training error, Loss_{data} represents data loss and Loss_{data} is determined based on a preset data loss calibration strategy, α is a first weight corresponding to Loss_{data}, Loss_{physics} represents physical residual loss and Loss_{physics} is determined based on the incompressible Navier-Stokes equations, and β is a second weight corresponding to Loss_{physics}.

Specifically, specific implementation steps of the graph neural network have been detailed in the prior art, which include three steps: encoding, processing, and decoding, and will not be repeated here; The training dataset here includes true wind speed component data and true pressure data, and includes but is not limited to generation through CFD (Computational Fluid Dynamics) simulation, to ensure the accuracy of training results.

It also needs to be noted that in order to improve physical consistency, the present application constructs physical residual loss based on the incompressible Navier-Stokes equations and introduces it into the construction of the preset loss function to realize training; Allowing the trained target physical-informed spatial mapping module to explicitly couple meteorological station-level prediction with physically-regularized spatial inference, thereby enabling the scheme to support end-to-end future global wind field prediction under sparse observation conditions.

In some embodiments, determining Loss_{data} based on a preset data loss calibration strategy comprises:

Determining Loss_{data} based on a first preset relational expression, and the first preset relational expression is:

LOSS_{data}=|u−ū|²+|v−v̅|²+|p−p̅|²

Wherein, u represents the predicted wind speed component data in the x direction corresponding to the grid node under the preset pedestrian-level structured grid obtained when predicting using the graph neural network to be trained, ū represents the true wind speed component data in the x direction corresponding to the grid node, v represents the predicted wind speed component data in the y direction corresponding to the grid node, v̅ represents the true wind speed component data in the y direction corresponding to the grid node, p represents the predicted pressure data corresponding to the grid node, and p̅ represents the true pressure data corresponding to the grid node.

In some embodiments, determining Loss_{physics} based on the incompressible Navier-Stokes equations comprises:

Determine Loss_{physics} based on a second preset relational expression, the second preset relational expression is:

LOSS_{physics}=MSE_{f}_{₁}+MSE_{f}_{₂}+MSE_{f}_{₃}

MSE_{f}_{₁} represents the mean square error corresponding to the continuity equation f₁ in the incompressible Navier-Stokes equations, MSE_{f}_{₂} represents the mean square error corresponding to the x-direction momentum equation f₂ in the incompressible Navier-Stokes equations, and MSE_{f}_{₃} represents the mean square error corresponding to the y-direction momentum equation f₃ in the incompressible Navier-Stokes equations;

Wherein, the incompressible Navier-Stokes equations are:

$$\{ \begin{matrix}{f}_{1} = {u}_{x} + {u}_{y} \\ {f}_{2} = {uu}_{x} + {vu}_{y} + {p}_{x} - \frac{1}{{R}_{e}} ( {u}_{xx} + {u}_{yy} ) \\ {f}_{3} = {uv}_{x} + {vv}_{y} + {p}_{y} - \frac{1}{{R}_{e}} ( {v}_{xx} + {v}_{yy} )\end{matrix}$$

Wherein, uₓ represents the first-order partial derivative of u with respect to the x direction, u_{y} represents the first-order partial derivative of u with respect to the y direction, pₓ represents the first-order partial derivative of p with respect to the x direction, Rₑ represents the Reynolds number, uₓₓ represents the second-order partial derivative of u with respect to the x direction, u_{yy} represents the second-order partial derivative of u with respect to the y direction, vₓ represents the first-order partial derivative of v with respect to the x direction, v_{y} represents the first-order partial derivative of v with respect to the y direction, vₓₓ represents the second-order partial derivative of v with respect to the x direction, and v_{yy} represents the second-order partial derivative of v with respect to the y direction.

It should be noted that in the present application, calculations for first-order partial derivatives and second-order partial derivatives can be obtained through automatic differentiation calculations.

As an effectiveness illustration of the technical scheme provided in the present application, targeting 30 meteorological stations randomly selected in the target city, utilizing the present scheme to determine predicted wind speed component data within a future time period, and utilizing a CFD simulation method to obtain true wind speed component data under this future time period to serve as a validation benchmark for illustration:

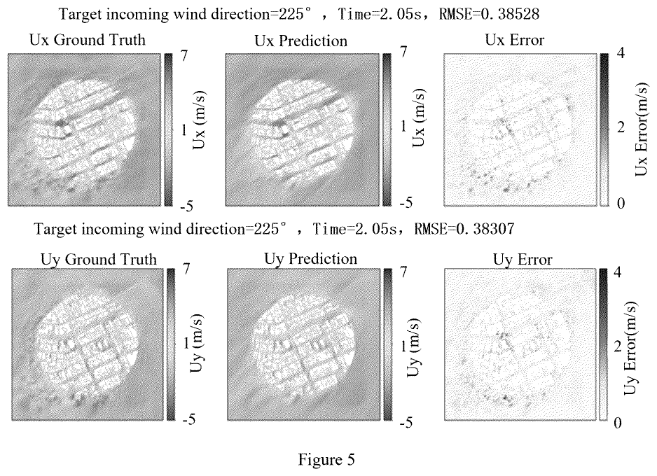

For comparative illustration of representative moments in the future time period under different target incoming wind directions, please refer to FIG. 5, which is a schematic diagram comparing prediction results with validation benchmarks provided by the present invention, and presents a comparison illustration of the predicted wind speed component data of the present scheme and the true wind speed component data obtained by the CFD simulation method at the moment Time=2.05 seconds (i. e., 2.05 seconds after the current moment) under the condition of a target incoming wind direction=225°. Specifically, the first column in FIG. 5 corresponds to the results of the CFD simulation method, with the first row of the first column corresponding to true wind speed component data in the x direction (i. e., Ux Ground Truth), and the second row of the first column corresponding to true wind speed component data in the y direction (i. e., Uy Ground Truth); The second column in FIG. 5 corresponds to prediction results of the present scheme, with the first row of the second column corresponding to predicted wind speed component data in the x direction (i. e., Ux Prediction), and the second row of the second column corresponding to predicted wind speed component data in the y direction (i. e., Uy Prediction); In the third column of FIG. 5, Ux Error is used to indicate the error distribution in the x direction, and its value is equal to the absolute value of the difference between the true wind speed component data in the x direction and the true wind speed component data in the x direction, Uy Error is used to indicate the error distribution in the y direction, and its value is equal to the absolute value of the difference between the true wind speed component data in the y direction and the true wind speed component data in the y direction; In addition, using RMSE (Root Mean Square Error) as an evaluation metric, here the RMSE in the x direction=0.38528, and the RMSE in the y direction=0.38307.

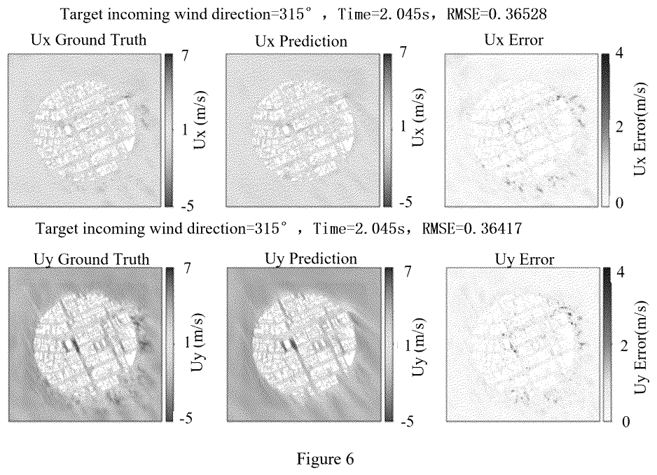

Please refer to FIG. 6, which is another schematic diagram comparing prediction results with validation benchmarks provided by the present invention, and presents a comparison illustration of the predicted wind speed component data of the present scheme and the true wind speed component data obtained by the CFD simulation method at the moment Time=2.045 seconds (i. e., 2.045 seconds after the current moment) under the condition of a target incoming wind direction=315°. Specifically, the first column in FIG. 6 corresponds to the results of the CFD simulation method, with the first row of the first column corresponding to true wind speed component data in the x direction, and the second row of the first column corresponding to true wind speed component data in the y direction; The second column in FIG. 6 corresponds to prediction results of the present scheme, with the first row of the second column corresponding to predicted wind speed component data in the x direction, and the second row of the second column corresponding to predicted wind speed component data in the y direction; In the third column of FIG. 6, Ux Error is used to indicate the error distribution in the x direction, and its value is equal to the absolute value of the difference between the true wind speed component data in the x direction and the true wind speed component data in the x direction, Uy Error is used to indicate the error distribution in the y direction, and its value is equal to the absolute value of the difference between the true wind speed component data in the y direction and the true wind speed component data in the y direction; In addition, the RMSE (Root Mean Square Error) in the x direction=0.36528, and the RMSE in the y direction=0.36417.

Corresponding to FIG. 5 and FIG. 6, looking at the overall distribution of the two wind speed components, it can be seen that the predicted wind field presents a clear directional pattern. The target physical-informed spatial mapping module accurately captures large-scale urban wind field dynamics, especially the phenomena of airflow acceleration and deceleration around buildings; Wind speeds on the windward side of building complexes are significantly higher, while enclosed internal areas and the leeward side of buildings show pronounced low wind speed characteristics. On broad streets aligned with the dominant wind direction, wind speed significantly increases, whereas in some narrow and winding streets, the enhancement of wind speed is far less obvious; The error distribution situation further reveals that prediction errors in regions with high turbulent kinetic energy are significantly larger than in other regions, which is consistent with the inherent complexity and strong nonlinear characteristics of turbulence; Overall, the present scheme demonstrates strong stability under target incoming wind directions of 225° and 315°, and its deviation from results obtained by the CFD simulation method is relatively small.

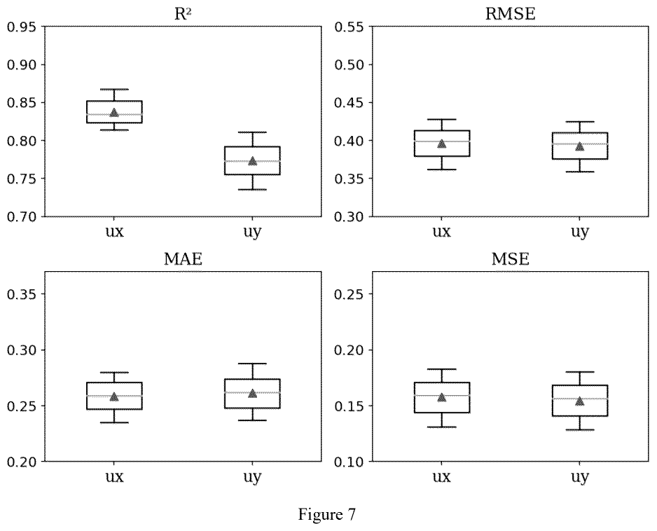

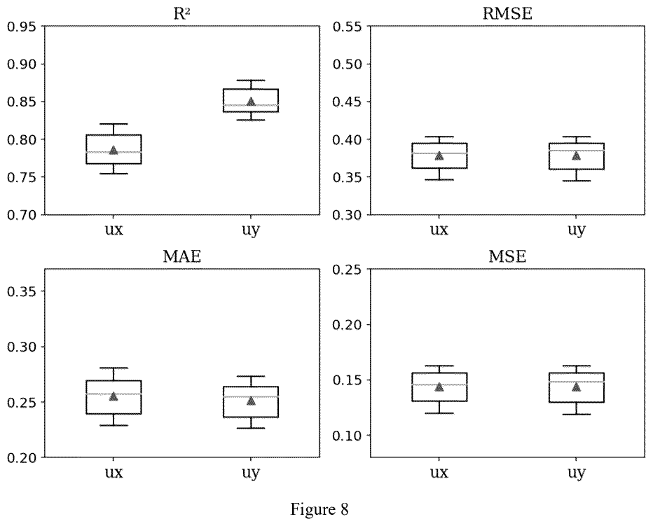

To more accurately quantify the prediction accuracy and stability of the present scheme under target incoming wind directions of 225° and 315°, four key metrics, R² (coefficient of determination), RMSE, MAE (Mean Absolute Error), and MSE (Mean Squared Error), along with predicted wind speed component data in the x direction (abbreviated as ux below) and predicted wind speed component data in the y direction (abbreviated as uy below), are utilized for evaluation and illustration. Please refer to FIG. 7 and FIG. 8. FIG. 7 is a schematic diagram of the statistical distribution of predicted wind speed component data in the x direction and predicted wind speed component data in the y direction under a 225° target incoming wind direction provided by the present invention. FIG. 8 is a schematic diagram of the statistical distribution of predicted wind speed component data in the x direction and predicted wind speed component data in the y direction under a 315° target incoming wind direction provided by the present invention. Then, R² boxplots show that the median and mean of ux and uy nearly coincide and are both around 0.8, which indicates that the present scheme has strong explanatory power for the relationship between prediction data and validation benchmark data; For RMSE, MAE, and MSE, their boxes are all in a low range, indicating that the present scheme has excellent overall prediction performance; In addition, the box heights of all metrics are moderate and no outliers are observed, which highlights the strong stability of the present scheme; Additionally, to more intuitively display the performance of the model of the present scheme under target incoming wind directions of 225° and 315°, Table 1 summarizes the average values of various metrics on the validation set.

TABLE 1

| Target | | | | | | |
|---|---|---|---|---|---|---|
| incoming | ux | ux | ux | uy | uy | uy |
| wind | R² | RMSE | MAE | R² | RMSE | MAE |
| direction | Average | Average | Average | Average | Average | Average |
| 225° | 0.8377 | 0.3973 | 0.2587 | 0.7809 | 0.3933 | 0.2614 |
| 315° | 0.7861 | 0.3791 | 0.2554 | 0.8478 | 0.3792 | 0.2513 |

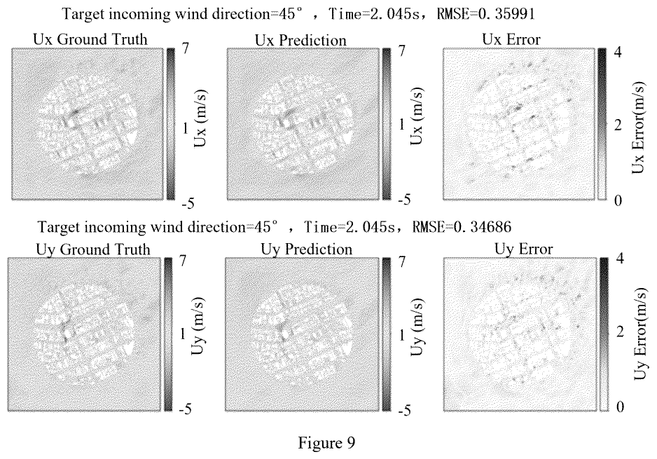

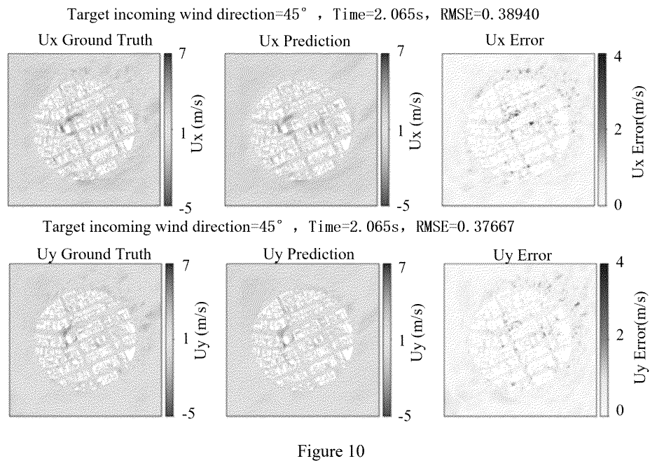

Further, targeting two representative moments in the future time period under a 45° target incoming wind direction for comparative illustration, please refer to FIG. 9 and FIG. 10. FIG. 9 is a schematic diagram comparing prediction results with validation benchmarks under a 45° target incoming wind direction provided by the present invention, here presenting a comparison illustration of the predicted wind speed component data of the present scheme and the true wind speed component data obtained by the CFD simulation method at the moment Time=2.045 seconds (i. e., 2.045 seconds after the current moment). FIG. 10 is another schematic diagram comparing prediction results with validation benchmarks under a 45° target incoming wind direction provided by the present invention, here presenting a comparison illustration of the predicted wind speed component data of the present scheme and the true wind speed component data obtained by the CFD simulation method at the moment Time=2.065 seconds (i. e., 2.065 seconds after the current moment). The meanings represented by each column and each row in the figures are consistent with the definitions in FIG. 5 and FIG. 6 above, and will not be repeated here. Relying on FIG. 9 and FIG. 10, it can be seen that the present scheme demonstrates strong stability under a 45° target incoming wind direction, and its deviation from results obtained by the CFD simulation method is relatively small. Please refer to Table 2. Table 2 intuitively displays the average values of various metrics within the future time period for the model of the present scheme under a 45° target incoming wind direction.

TABLE 2

| ux R² | ux RMSE | ux MAE | uy R² | uy RMSE | uy MAE |
|---|---|---|---|---|---|
| Average | Average | Average | Average | Average | Average |
| 0.8513 | 0.3752 | 0.2475 | 0.7921 | 0.3727 | 0.2529 |

In addition, from the perspective of required prediction time, corresponding to a future time period of 10 minutes, the present scheme requires 20,000 seconds, whereas the CFD simulation method requires 900,000 seconds; It can be seen that the scheme provided by the present application can significantly improve wind field prediction efficiency and greatly reduce computational costs while ensuring accuracy, possesses strong short-term prediction capability for urban wind fields, and has considerable potential and good scalability for complex urban areas and multi-wind direction scenarios.

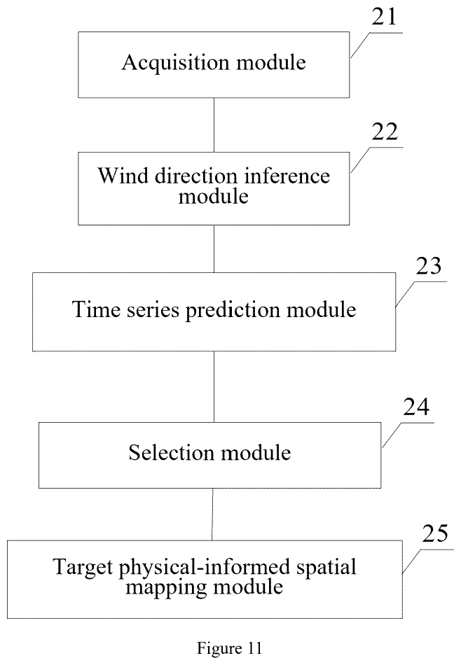

Please refer to FIG. 11, which is a schematic structural diagram of short-term prediction system for urban low-altitude wind fields provided by the present invention.

The short-term prediction system for urban low-altitude wind fields comprises:
An acquisition module 21, configured for obtaining the historical wind speed component data of A meteorological stations in a target city within a preset historical time period, where A is an integer greater than 1;
A wind direction inference module 22, configured for obtaining a target incoming wind direction corresponding to a target city according to historical wind speed component data;
A time series prediction module 23, configured for obtaining predicted wind speed component data of A meteorological stations in a future time period according to the historical wind speed component data;
A selection module 24, configured for selecting a target physical-informed spatial mapping module 25 corresponding to the target incoming wind direction from pre-trained physical-informed spatial mapping modules;
The target physical-informed spatial mapping module 25, configured for obtaining the predicted wind speed component data and the predicted pressure data corresponding to each grid node under the preset pedestrian-level structured grid, according to the predicted wind speed component data, the preset pedestrian-level structured grid corresponding to the target city, and a binary mask vector for buildings in the target city.

For the introduction to short-term prediction system for urban low-altitude wind fields here, please refer to the embodiment of short-term prediction method for urban low-altitude wind fields above, which will not be repeated here.

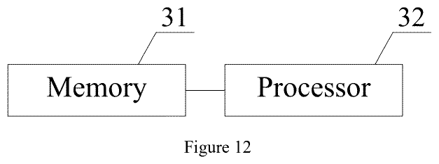

Please refer to FIG. 12, which is a schematic structural diagram of short-term prediction device for urban low-altitude wind fields provided by the present invention.

The short-term prediction device for urban low-altitude wind fields comprises:
A memory 31, configured for storing a computer program;
A processor 32, configured to, when executing a computer program, implement the steps of short-term prediction method for urban low-altitude wind fields as described above.

For the introduction to short-term prediction device for urban low-altitude wind fields here, please refer to the embodiment of short-term prediction method for urban low-altitude wind fields above, which will not be repeated here.

Although the present disclosure has been disclosed as above, the protection scope of the present disclosure is not limited thereto. Those skilled in the art may make various changes and modifications without departing from the spirit and scope of the present disclosure, and all such changes and modifications shall fall within the protection scope of the present invention.

Moreover, each embodiment in this specification is described in a progressive manner, with each embodiment focusing on differences from other embodiments, and identical or similar parts among various embodiments may simply be referred to one another. Relational terms such as first and second are only used to distinguish one entity or operation from another entity or operation, and do not necessarily require or imply any such actual relationship or sequence among these entities or operations. The terms “comprises”, “contains” or any of their other variants are intended to cover non-exclusive inclusions, thereby enabling a process, method, article, or device including a series of elements to not only include those elements, but also include other elements not explicitly listed, or further include elements inherent to such process, method, article, or device. In the absence of more limitations, an element defined by the phrase “comprising one” does not exclude the existence of additional identical elements in the process, method, article, or device comprising said element.

In addition, the present invention will not be limited to the embodiments shown herein, but is to be accorded the widest scope consistent with the principles and novel features disclosed herein.

1. Short-term prediction method for urban low-altitude wind fields, characterized in that it comprises:
Obtain the historical wind speed component data of A meteorological stations in a target city within a preset historical time period, where A is an integer greater than 1;
Input the historical wind speed component data as an input item into a wind direction inference module to obtain the target incoming wind direction corresponding to the target city;
Input the historical wind speed component data as an input item into a time series prediction module to obtain predicted wind speed component data of A meteorological stations in a future time period;
Select a target physical-informed spatial mapping module corresponding to the target incoming wind direction from pre-trained physical-informed spatial mapping modules;
Input the predicted wind speed component data, a preset pedestrian-level structured grid corresponding to the target city, and a binary mask vector for buildings in the target city as input items into the pre-trained target physical-informed spatial mapping module, to obtain the predicted wind speed component data and the predicted pressure data corresponding to each grid node under the preset pedestrian-level structured grid.

2. The short-term prediction method for urban low-altitude wind fields according to claim 1, characterized in that inputting the historical wind speed component data as an input item into a wind direction inference module to obtain the target incoming wind direction corresponding to the target city comprises:
Perform feature extraction on the historical wind speed component data to obtain a feature vector;
Use a first linear layer to perform linear transformation processing on the feature vector to obtain a first linear output vector, and use a first activation function to activate the first linear output vector to obtain a first activation vector;
Use a second linear layer to perform linear transformation processing on the first activation vector to obtain a second linear output vector, and use the first activation function to activate the second linear output vector to obtain a second activation vector; Wherein, the dimension of the first linear output vector is higher than the dimension of the second linear output vector;
Use a third linear layer to perform linear transformation processing on the second activation vector to obtain a third linear output vector; Wherein, the dimension of the second linear output vector is higher than the dimension of the third linear output vector;
Determine the target incoming wind direction corresponding to the target city based on the third linear output vector and a preset direction category determination strategy.

3. The short-term prediction method for urban low-altitude wind fields according to claim 2, characterized in that determining the target incoming wind direction corresponding to the target city based on the third linear output vector and a preset direction category determination strategy comprises:
Use a Softmax function to normalize the third linear output vector to obtain probability values corresponding to X incoming wind directions, where X is equal to the dimension of the third linear output vector;
Select the maximum value among the probability values to determine the incoming wind direction corresponding to the maximum value as the target incoming wind direction corresponding to the target city.

4. The short-term prediction method for urban low-altitude wind fields according to claim 1, characterized in that inputting the historical wind speed component data as an input item into a time series prediction module to obtain predicted wind speed component data of A meteorological stations in a future time period comprises:
Merge the historical wind speed component data corresponding to each historical time step within the preset historical time period into historical wind speed data;
For the historical wind speed data under each historical time step, execute the following steps:
Based on a forward LSTM layer, start from the historical wind speed data under the first historical time step and sequentially process to the historical wind speed data under the last historical time step, to correspondingly obtain a forward hidden state representation under each historical time step;
Based on a backward LSTM layer, start from the historical wind speed data under the last historical time step and reversely process to the historical wind speed data under the first historical time step, to correspondingly obtain a backward hidden state representation under each historical time step;
For each historical time step, concatenate the forward hidden state representation and the backward hidden state representation under the historical time step to obtain a bidirectional hidden state representation under the historical time step;
Determine the predicted wind speed component data of the A meteorological stations in the future time period according to the bidirectional hidden state representation under each historical time step.

5. The short-term prediction method for urban low-altitude wind fields according to claim 4, characterized in that determining the predicted wind speed component data of the A meteorological stations in the future time period according to the bidirectional hidden state representation under each historical time step comprises:
Use a dropout layer to perform a random dropout operation on the bidirectional hidden state under each historical time step to obtain a regularized bidirectional hidden state representation under each historical time step, and input it as an input item to a fully connected layer for mapping processing, to obtain the predicted wind speed data of the A meteorological stations in the future time period;
Decompose the predicted wind speed data in the x direction and the y direction, respectively, to correspondingly obtain the predicted wind speed component data in the x direction and the predicted wind speed component data in the y direction.

6. The short-term prediction method for urban low-altitude wind fields according to claim 1, characterized in that the physical-informed spatial mapping module is a graph neural network, and the graph neural network is pre-trained based on a training dataset and a preset loss function;
The preset loss function is:
Loss=αLoss_{data}+βLoss_{physics}
Wherein, Loss represents training error, Loss_{data} represents data loss and Loss_{data} is determined based on a preset data loss calibration strategy, α is a first weight corresponding to Loss_{data}, Loss_{physics} represents physical residual loss and Loss_{physics} is determined based on the incompressible Navier-Stokes equations, and β is a second weight corresponding to Loss_{physics}.

7. The short-term prediction method for urban low-altitude wind fields according to claim 6, characterized in that determining Loss_{data} based on a preset data loss calibration strategy comprises:
Determining Loss_{data} based on a first preset relational expression, and the first preset relational expression is:
Loss_{data}=|u−ū|²+|v−v̅|²+|p−p̅|²
Wherein, u represents the predicted wind speed component data in the x direction corresponding to the grid node under the preset pedestrian-level structured grid obtained when predicting using the graph neural network to be trained, ū represents the true wind speed component data in the x direction corresponding to the grid node, v represents the predicted wind speed component data in the y direction corresponding to the grid node, v̅ represents the true wind speed component data in the y direction corresponding to the grid node, p represents the predicted pressure data corresponding to the grid node, and p̅ represents the true pressure data corresponding to the grid node.

8. The short-term prediction method for urban low-altitude wind fields according to claim 7, characterized in that determining Loss_{physics} based on the incompressible Navier-Stokes equations comprises:
Determine Loss_{physics} based on a second preset relational expression, the second preset relational expression is:
Loss_{physics}=MSE_{f}_{₁}+MSE_{f}_{₂}+MSE_{f}_{₃}
MSE_{f}_{₁} represents the mean square error corresponding to the continuity equation f₁ in the incompressible Navier-Stokes equations, MSE_{f}_{₂} represents the mean square error corresponding to the x-direction momentum equation f₂ in the incompressible Navier-Stokes equations, and MSE_{f}_{₃} represents the mean square error corresponding to the y-direction momentum equation f₃ in the incompressible Navier-Stokes equations;
Wherein, the incompressible Navier-Stokes equations are:
$$\{ \begin{matrix}{f}_{1} = {u}_{x} + {u}_{y} \\ {f}_{2} = {uu}_{x} + {vu}_{y} + {p}_{x} - \frac{1}{{R}_{e}} ( {u}_{xx} + {u}_{yy} ) \\ {f}_{3} = {uv}_{x} + {vv}_{y} + {p}_{y} - \frac{1}{{R}_{e}} ( {v}_{xx} + {v}_{yy} )\end{matrix}$$
Wherein, uₓ represents the first-order partial derivative of u with respect to the x direction, u_{y} represents the first-order partial derivative of u with respect to the y direction, pₓ represents the first-order partial derivative of p with respect to the x direction, Rₑ represents the Reynolds number, uₓₓ represents the second-order partial derivative of u with respect to the x direction, u_{yy} represents the second-order partial derivative of u with respect to the y direction, vₓ represents the first-order partial derivative of v with respect to the x direction, v_{y} represents the first-order partial derivative of v with respect to the y direction, vₓₓ represents the second-order partial derivative of v with respect to the x direction, and v_{yy} represents the second-order partial derivative of v with respect to the y direction.

9. Short-term prediction system for urban low-altitude wind fields, characterized in that it comprises:
An acquisition module, configured for obtaining the historical wind speed component data of A meteorological stations in a target city within a preset historical time period, where A is an integer greater than 1;
A wind direction inference module, configured for obtaining the target incoming wind direction corresponding to the target city according to the historical wind speed component data;
A time series prediction module, configured for obtaining the predicted wind speed component data of the A meteorological stations in a future time period according to the historical wind speed component data;
A selection module, configured for selecting a target physical-informed spatial mapping module corresponding to the target incoming wind direction from pre-trained physical-informed spatial mapping modules;
The target physical-informed spatial mapping module, configured for obtaining the predicted wind speed component data and the predicted pressure data corresponding to each grid node under the preset pedestrian-level structured grid, according to the predicted wind speed component data, the preset pedestrian-level structured grid corresponding to the target city, and a binary mask vector for buildings in the target city.

10. Short-term prediction device for urban low-altitude wind fields, characterized in that it comprises:
A memory, configured for storing a computer program;
A processor, configured to, when executing the computer program, implement the steps of short-term prediction method for urban low-altitude wind fields according to claim 1.
